(19) United States
(12) Patent Application Publication
(10) Pub. No.: US 2005/0109905 A1
(43) Pub. Date: May 26, 2005

(54) CD stand

(76) Inventors: Eric Daniel Andre Jeandemange, Oklahoma City, OK (US); Alain Dervin, Toulon (FR)

Correspondence Address: Randal D. Homburg, P.O. Box 10470, Midwest City, OK, 73140-1470, US

(21) Appl. No.: 11/010,019

(22) Filed: Dec. 11, 2004

Related U.S. Application Data
(62) Division of application No. 10/674,673, filed on Sep. 30, 2003.

(51) Int. Cl. G11B 7/085

(52) U.S. Cl. 248/309.2

(57) ABSTRACT

A pedestal CD stand for holding a plurality of compact disks includes a weighted pedestal base, a neck and a flanged CD support peg upon which the compact disks are placed in a stack, the flanged CD support peg having a central stem placed within the center holes of the compact disks, with a lower flange which is slightly larger than the center holes of the compact disk retaining the compact disks on the pedestal CD stand. A second embodiment of the pedestal CD stand includes a weighted base, a plurality of necks and a plurality of flanged CD support pegs arranged at different heights and angles for holding several stacks of compact disks. The CD stand may be placed upon a flat surface, or in alternate embodiments, attached to a wall as a sconce.

### CROSS REFERENCE TO RELATED APPLICATIONS

This is a divisional application of parent utility application Ser. No. 10/674,673 filed on Sep. 30, 2003 by the same inventors, filed pursuant to election, based on the office action of Oct. 15, 2004, such parent application in the process of examination without final action, assigned to Group Art Unit 3632, Examiner Jonathon A. Szumny.

### I. BACKGROUND OF THE INVENTION

1. Field of Invention

A pedestal CD stand for holding a plurality of compact disks includes a weighted pedestal base, a neck and a flanged CD support peg upon which the compact disks are placed in a stack, the flanged CD support peg having a central stem placed within the center holes of the compact disks, with a lower flange which is slightly larger than the center holes of the compact disk retaining the compact disks on the pedestal CD stand. A second embodiment of the pedestal CD stand includes a weighted base, a plurality of necks and a plurality of flanged CD support pegs arranged at different heights and angles for holding several stacks of compact disks. The CD stand may be placed upon a flat surface, or in alternate embodiments, attached to a wall as a sconce.

2. Description of Prior Art

The following United States patents were discovered and are disclosed within this application for utility patent. All relate to compact disk storage devices. These prior art CD holders tended to relate to two modes of compact disk storage. First, there were several design patent noted which merely hold CD jewel cases in a stacked arrangement vertically or horizontally. These type devices are shown by example in U.S. Pat. No. 5,590,770 to Yeh, D467,763 to Hsieh, D470,001 to Munroe, II, D462,223 to Beer, D452,405 to Karlsson and D371,036 to Sandberg.

Second, there were types of CD holders that formed a sleeve within which an individual CD is stored, some having clear display, as noted in U.S. Patents No. D435,118 to O'Mullane, D356,453 to Fossier, and D379,896 to Friedman. a fixed position pedestal incorporated into a CD jewel box or container is also disclosed in D451,299 to Cheng for holding a CD within a case, shown best in FIG. 8 of that patent.

The present CD stand allows for the display and stacking of multiple compact disks, not within the accompanying case, in a manner in which only the center hole in the disk is engaged by the central stem with the outer perimeter of the center hole, engaged by the lower flange, elevated above a surface upon which the CD stand is placed, or away from the wall where it is hung, preferably at or near the location of the CD player or computer where it is generally used.

### II. SUMMARY OF THE INVENTION

Current CD holders and stands which are able to hold multiple CD's are generally embodied into several types of devices. There are those that allow for the storage of the CDs in their encasements, which requires a substantial amount of space. Other devices allow for the CDs to be removed from their plastic cases and stored in plastic sleeves and even bound into magazines for carrying CDs. CDs may also be stored in stacked cases on a singular large container, as in the type of case that CD-ROMs are sold, with the bottom most CD resting flat with the other CDs stacked upon the first CD. These serve utilitarian purpose, but are generally of no aesthetic value, are not intended for hanging on a wall, nor are they provided to retain a stack of CDs in a manner providing minimal contact with the disk surfaces.

The primary objective of the present CD stand is to provide a device allowing for the retention of multiple stacked CDs with minimal contact between the CD and the stand, restricting contact to areas of the CD where information is not stored. A secondary objective of the CD stand is to provide for the storage of multiple CDs with a nominal amount of table space or wall space required to support the CD stand. A third objective of the CD stand is to provide the CD stand with a variety of shaped flanged support pegs, a variety of finishes and a variety of styles to make the presentation of the CD stand suitable to a variety of differing tastes of the potential users.

### III. DESCRIPTION OF THE DRAWINGS

The following drawings are submitted with this utility patent application.

FIG. 5 is a perspective view of the second embodiment of the second embodiment of the CD stand for a vertical surface.

FIG. 6 is a side view of the second embodiment of the CD stand as applied to avertical surface.

### IV. DESCRIPTION OF THE PREFERRED EMBODIMENT

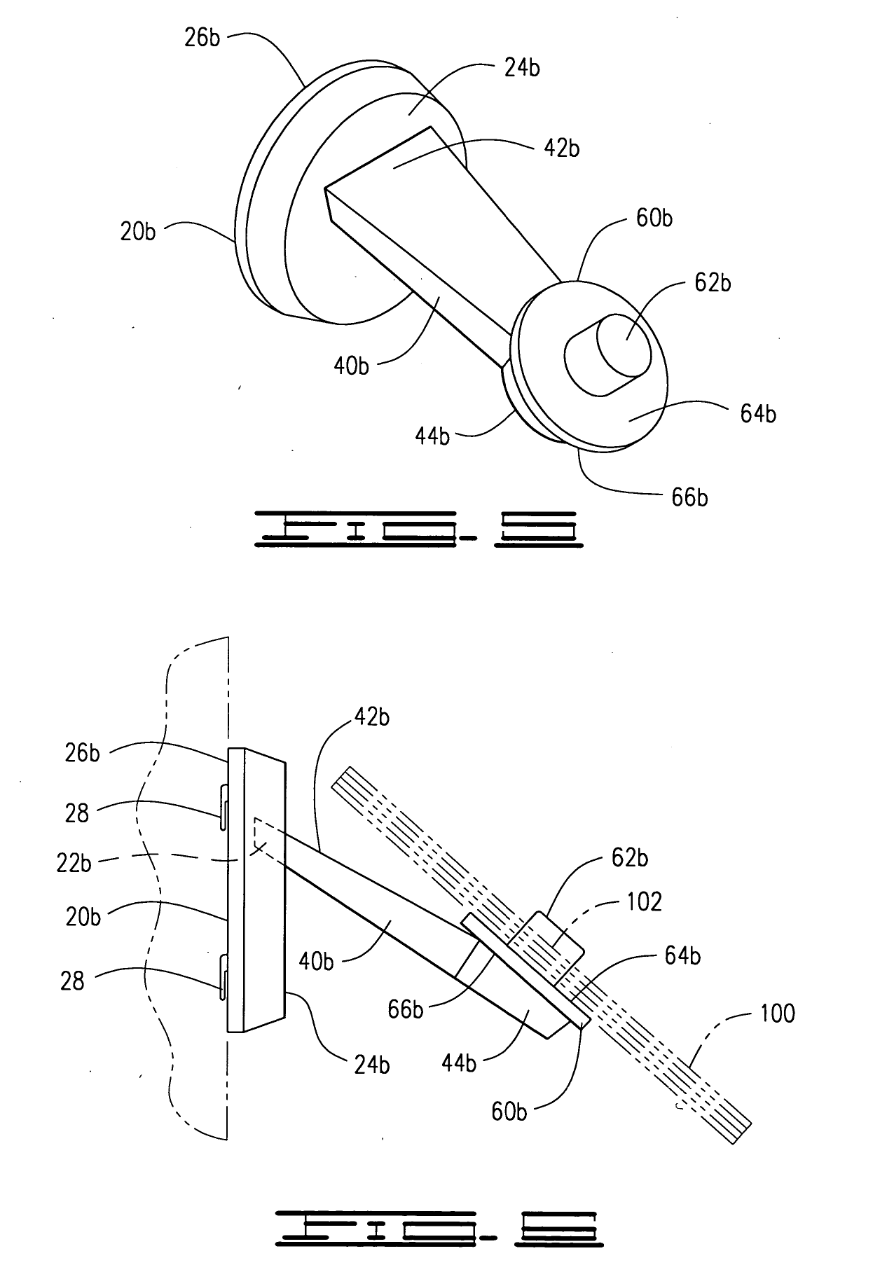

A CD stand for storing and displaying compact disks or DVDs, hereinafter referenced as a CD 100, is provided in several different embodiments, but basically is provided as shown in FIGS. 5-6 of the drawings as comprising a weighted base 20b, at least one elongated neck 40b and at least one flanged CD support peg 60b, the base 20b being suited for placement on a flat surface, with the flanged CD support peg 60b having a central stem 62b adapted to hold a stack of CDs through a central hole 102 in the CDs and a lower flange 64b slightly larger than the central hole 102 of the CD 100, supporting the stack of CDs 100 at an angle.

Any color or print may be used to adorn this embodiment of the CD stand. The CD stand may also be adapted to a vertical mounting, shown in FIGS. 5-6 of the drawings, similar to a wall sconce. In this event, the base 20b may be modified by the incorporation of an attaching means 28 into a lower surface 26b of the base 20b. This attaching means 28 may be a hook, a hanging slot or the application of an adhesive to the lower surface 26b. The flanged CD support peg 60b should be oriented with the central stem 62b point relatively upward, as in FIGS. 5-6.

While the invention has been particularly shown and described with reference to a preferred embodiment thereof, it will be understood by those skilled in the art that changes in form and detail may be made therein without departing from the spirit and scope of the invention.

6. A CD stand for storing and displaying a stack of compact disks or DVDs, collectively referenced as CDs, on a vertical surface, comprising:
a weighted base having an upper surface containing an angled slot and a lower surface having an attaching means to attach said base to the vertical surface;
at least one elongated neck having a lower end inserted within said angled slot of said base; and
at least one flanged CD support peg having a lower surface to which an upper end of said neck is attached, said base, neck and flanged CD support peg forming a Z-shaped CD stand, said flanged CD support peg having a rounded cylindrical shaped central stem adapted to hold said stack of CDs through respective central holes in said stack of CDs and a lower flange slightly larger than said central holes of said stack of CDs, supporting said stack of CDs at an upward angle.
